(19) United States
(12) Patent Application Publication
(10) Pub. No.: US 2023/0076350 A1
(43) Pub. Date: Mar. 9, 2023

(54) STABILIZED UREA CONTAINING FERTILIZER BLENDS

(71) Applicant: SABIC Global Technologies B.V., Bergen op Zoom (NL)

(72) Inventors: Rajamalleswaramma KORIPELLY, Bangalore (IN); Ravi HEGDE, Bangalore (IN); Satish BURLA, Bangalore (IN); Samik GUPTA, Bangalore (IN)

(73) Assignee: SABIC Global Technologies B.V., Bergen op Zoom (NL)

(21) Appl. No.: 17/904,305

(22) PCT Filed: Feb. 25, 2021
(86) PCT No.: PCT/IB2021/051583

§ 371 Date: Aug. 16, 2022

Related U.S. Application Data
(60) Provisional application No. 62/983,166, filed on Feb. 28, 2020.

(51) Int. Cl. C05G 1/00; C05C 9/00; C05C 3/00; C05D 1/00; C05G 5/35; C05G 3/90

(52) U.S. Cl. CPC C05G 1/00; C05C 9/00; C05C 3/00; C05D 1/00; C05G 5/35; C05G 3/90

(57) ABSTRACT

A fertilizer blend containing 10 wt. % to 90 wt. % of a first particulate fertilizer composition and 10 wt. % to 90 wt. % of a second particulate fertilizer composition is disclosed. In the fertilizer blend, the second particulate fertilizer composition can be blended with the first particulate fertilizer composition. The first particulate fertilizer composition can include a core containing a binder, a pH buffering agent, and an urease inhibitor, and a shell containing urea, where the shell covers at least a portion of an outer surface of the core.

### CROSS REFERENCE TO RELATED APPLICATIONS

This application claims the benefit of priority of U.S. Provisional Application No. 62/983,166 filed Feb. 28, 2020, which is hereby incorporated by reference in its entirety.

### BACKGROUND OF THE INVENTION

### A. Field of the Invention

The invention generally concerns fertilizer blends containing 10 wt. % to 90 wt. % of a first particulate fertilizer composition containing urea and 10 wt. % to 90 wt. % of a second particulate fertilizer composition. In particular, the first particulate fertilizer composition can include particles having core shell structure, with a core containing a binder, a pH buffering agent, and an urease inhibitor, and a shell containing urea.

### B. Description of Related Art

To increase crop yield and satisfy the growing needs of an increasing population, more fertilizers are being used in agriculture. However, continuous use of fertilizer can lead to nutrient imbalance and loss of soil fertility. For example, extensive use of urea fertilizer, due to its rapid hydrolysis in the soil by soil bacteria, can cause deterioration of soil health and other environmental problems such as greenhouse emissions and groundwater contamination.

Hydrolysis of urea in soil can be counteracted by adding urease inhibitors to the fertilizer. Urease inhibitors reduce the amount of urea hydrolyzed, which reduces the amount of nitrogen lost through ammonia volatilization. While use of urease inhibitors in fertilizers has been employed as a solution to the problems of urea hydrolysis, there are certain difficulties in using these inhibitors. One problem is that some urease inhibitors are heat and moisture sensitive, and can also get degraded during storage. While attempts have been made to produce fertilizer compositions with stabilized urease inhibitors, these attempts have the potential to create additional problems and may not solve the aforementioned problems associated with urease inhibitors degradation. For example, WO2017100507A1 discloses use of basic components to improve urease inhibitor storage. One of the potential issues of using basic components is it may affect soil pH and negatively impact the soil health.

### SUMMARY OF THE INVENTION

A solution to at least some of the problems discussed above has been discovered. In one aspect, it was discovered that in some instances urease inhibitors such as N-(n-butyl) thiophosphoric triamide (NBPT), in addition to being heat and moisture sensitive, can also be degraded in the presence of plant fertilizers other than urea. A solution to this degradation issue was discovered. In one aspect, a solution resides in providing a fertilizer blend containing at least two separate particulate fertilizer compositions. The fertilizer blend can contain, i) a first particulate fertilizer composition containing core-shell fertilizer particles having a core containing an urease inhibitor, and a shell containing urea where the shell covers at least a portion of an outer surface of the core, and ii) a second particulate fertilizer composition containing an additional plant fertilizer other than urea. Without wishing to be bound by theory, providing the additional fertilizer as a separate particulate composition and further separating the urease inhibitor in the core from the additional fertilizer by the shell can help to stabilize the urease inhibitor and/or reduce urease inhibitor degradation.

One aspect of the present invention is directed to a fertilizer blend containing a first particulate fertilizer composition and a second particulate fertilizer composition, where the second particulate fertilizer composition can be blended with the first particulate fertilizer composition. The fertilizer blend can include 10 wt. % to 90 wt. % of the first particulate fertilizer composition and 10 wt. % to 90 wt. % of the second particulate fertilizer composition, based on the total weight of the fertilizer blend. In some aspects, the fertilizer blend is stable in storage for a longer period of time than some other fertilizer blends. In some instances, the fertilizer blend retains a temperature and/or moisture sensitive ingredient at over 40% of the original concentration for more than 14 days when stored at room conditions. In some instances, the fertilizer blend retains some of the temperature and/or moisture sensitive ingredient for more than 60 days when stored at room conditions. In some instances, the fertilizer blend retains a temperature and/or moisture sensitive ingredient at over 40% of the original concentration for more than 1 day when stored at 40±2° C. and 75±5% relative humidity. In some instances, the fertilizer blend retains some of the temperature and/or moisture sensitive ingredient for more than 15 days when stored at 40±2° C. and 75±5% relative humidity. In some instances, the temperature and/or moisture sensitive ingredient is a urease inhibitor. In some instances, the urease inhibitor is NBPT.

The first particulate fertilizer composition can contain particles having a core-shell structure with a core containing a binder, a pH buffering agent, and an urease inhibitor, and a shell containing urea, wherein the shell covers at least a portion of an outer surface of the core. In some aspects, the shell can contain 50 wt. % to 100 wt. %, preferably 85 wt. % to 100 wt. %, of urea, based on the total weight of the shell. In one instance, the shell does not include any other fertilizes (e.g., (MAP), diammonium phosphate (DAP), muriate of potash (MOP), monopotassium phosphate (MKP), triple super phosphate (TSP), rock phosphate, single super phosphate (SSP), etc.) other than urea. In some aspects, the shell consists essentially of or consists of urea. The shell can make up 70 to 99 wt. %, preferably 90 to 97 wt. %, or about 95 wt. %, of the total weight of the first particulate fertilizer composition, and the core can make up 1 to 30 wt. %, preferably 3 to 10 wt. %, 3 to 7 wt. %, or about 5 wt. % of the total weight of the first particulate fertilizer composition.

In some aspects, the binder can include plaster of paris, flour, chalk powder, bleached wheat flour, starch, gluten, kaolin, bentonite, or colloidal silica or any combination thereof, preferably plaster of paris, and/or bleached wheat flour. In some aspects, the core can contain 10 wt. % to 95 wt. %, preferably 25 wt. % to 65 wt. %, of the binder such as plaster of paris and/or bleached wheat flour, based on the total weight of the core. In some aspects, the pH buffering agent can be CaCO₃, Na₂CO₃, K₂CO₃, MgO, KH₂PO₄, NaHCO₃, or MgCO₃ or any combination thereof, preferably CaCO₃. In some aspects, the CaCO₃ can be included in the core as chalk powder. In some aspects, the core can contain 5 wt. % to 60 wt. %, preferably 30 wt. % to 55 wt. % of the pH buffering agent such as chalk powder, based on the total weight of the core.

In some aspects, the urease inhibitor can include a thiophosphoric triamide derivative, preferably N-(n-butyl) thiophosphoric triamide (NBPT). In some aspects, the core can include 1 wt. % to 5 wt. %, of the urease inhibitor such as NBPT, based on the total weight of the core.

The core can optionally contain a plasticizer. In some aspects, the plasticizer can have a melting point greater than 150° C. In some aspects, the plasticizer can contain hydroxypropyl methylcellulose (HPMC), carboxymethyl cellulose, polyethylene glycol (PEG), guar gum, locust bean gum, xanthan gum, a natural gum, lignosulfonates, or hydroxyethylcellulose or any combination thereof, preferably HPMC. In some aspects, the core can contain 0.01 wt. % to 5 wt. % of the plasticizer, such as HPMC, based on the total weight of the core.

The core and/or the shell can optionally contain a nitrification inhibitor. In some aspects, the nitrification inhibitor can contain 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1,2,4-thiadiazol (Terrazole), 2-Amino-4-chloro-6-methyl-pyrimidine (AM), 2-Mercapto-benzothiazole (MBT), or 2-Sulfanimalamidothiazole (ST) or any combination thereof, preferably DCD. In some particular aspects, the core can contain 10 wt. % to 30 wt. % of the nitrification inhibitor such as DCD, based on the total weight of the core.

The core can optionally contain a filler. In some aspects, the filler can contain silica, dried distillers grains with solubles (DDGS), MgO, CaO, bone mill powder, chalk powder, rice husk or any combination thereof. In some aspects, the pH buffer, such as CaCO₃, in the core can also function as a filler in addition to its function as a pH buffering agent. In some aspects, the core can contain 1 wt. % to 60 wt. % of the filler.

The second particulate fertilizer composition can contain a plant fertilizer other than urea. In some aspects, the second particulate fertilizer composition can contain ammonium sulfate, monoammonium phosphate (MAP), diammonium phosphate (DAP), muriate of potash (MOP), triple super phosphate (TSP), rock phosphate, single super phosphate (SSP), a potassium phosphate fertilizer or any combination thereof. In some aspects, the potassium phosphate fertilizer can be monopotassium phosphate (MKP). In some aspects, the second particulate fertilizer composition can further contain urea.

In some particular aspects, the second particulate fertilizer composition can contain MAP. In some instances, the fertilizer blend can contain 30 wt. % to 70 wt. % of the first particulate fertilizer composition, and 30 wt. % to 70 wt. % of MAP, based on the total weight of the fertilizer blend. The first particulate fertilizer composition can include core-shell particles with a core containing 30 wt. % to 50 wt. % of plaster of paris, 5 wt. % to 20 wt. % of bleached wheat flour, 30 wt. % to 55 wt. % of a pH buffering agent such as chalk powder, 1 wt. % to 5 wt. %, of an urease inhibitor such as NBPT, 0.01 wt. % to 2 wt. % of a plasticizer such as HPMC, based on the total weight of the core, and a shell containing 90 wt. % to 100 wt. %, of urea, based on the total weight of the shell.

In some particular aspects, the second particulate fertilizer composition can contain MAP and MOP. In some instances, the fertilizer blend can contain 10 wt. % to 50 wt. % of the first particulate fertilizer composition, 30 wt. % to 70 wt. % of MAP, and 5 wt. % to 50 wt. % of MOP, based on the total weight of the fertilizer blend. The first particulate fertilizer composition can include core-shell particles with a core containing 30 wt. % to 50 wt. % of plaster of paris, 5 wt. % to 20 wt. % of bleached wheat flour, 30 wt. % to 55 wt. % of a pH buffering agent such as chalk powder, 1 wt. % to 5 wt. %, of an urease inhibitor such as NBPT, 0.01 wt. % to 2 wt. % of a plasticizer such as HPMC, based on the total weight of the core, and a shell containing 90 wt. % to 100 wt. %, of urea, based on the total weight of the shell.

In some particular aspects, the second particulate fertilizer composition can contain ammonium sulfate. In some instances, the fertilizer blend can contain 50 wt. % to 90 wt. % of the first particulate fertilizer composition, and 10 wt. % to 50 wt. % of ammonium sulfate, based on the total weight of the fertilizer blend. The first particulate fertilizer composition can include core-shell particles with a core containing 30 wt. % to 50 wt. % of plaster of paris, 5 wt. % to 20 wt. % of bleached wheat flour, 30 wt. % to 55 wt. % of a pH buffering agent such as chalk powder, 1 wt. % to 5 wt. %, of an urease inhibitor such as NBPT, 0.01 wt. % to 2 wt. % of a plasticizer such as HPMC, based on the total weight of the core, and a shell containing 90 wt. % to 100 wt. %, of urea, based on the total weight of the shell.

In some aspects, less than 60 wt. % of the urease inhibitor in the fertilizer blend is lost after being stored in ambient conditions for 14 days. In some aspects, the amount of the urease inhibitor in the fertilizer blend lost after being stored in ambient condition for 14 days is less than 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, or 21 wt. % or is between any two of those values.

The core of the core-shell particles can be of any suitable shape, non-limiting shapes includes spherical, cuboidal, cylindrical, puck shape, oval, and oblong shapes. In some aspects, the core can be of cylindrical shape with a circular, elliptical, ovular, triangular, square, rectangular, pentagonal, or hexagonal cross section, although cylindrical shaped core having a cross-section of other shapes can also be made. In some aspects, the core can have a dimension such as length, width, height and/or cross-sectional diameter between 0.5 mm to 2.5 mm. In some aspects, the core can have a substantially cylindrical shape with a length of the cylinder 0.5 mm to 2 mm, or 0.7 mm to 1.6 mm, and a circular cross-section with diameter 0.5 mm to 1.5 mm, or 0.8 mm to 1.2 mm, wherein the cross-section is taken along a plane perpendicular to the length of the cylinder. In some aspects, the shell can form a coat with a thickness of 0.1 mm to 8 mm, or 1 mm to 6 mm, or 2 mm to 4 mm over at least a portion of the outer surface of the core. The core-shell particles of the first particulate composition can also have a variety of shape and sizes. Non-limiting shapes of the core-shell particles include spherical, cylindrical, puck, oval, or oblong shape. In some aspects, the core-shell particle can have a longest dimension 1 to 8 mm. In some particular aspects, the core can have a substantially cylindrical shape with length 0.7 mm to 1.6 mm and a substantially circular cross-section with diameter 0.8 mm to 1.2 mm, the shell can form a coat over at least a portion of the outer surface of the core and the core-shell fertilizer particle can have a substantially spherical shape with diameter 1 mm to 5 mm, 1 mm to 4 mm, 2 mm to 5 mm, or 2 mm to 4 mm. The core can comprise 1 to 10 wt. %, preferably 3 to 7 wt. %, or about 5 wt. % of the total weight of a core-shell particle or a plurality of core-shell particles.

In some aspects, the shell can cover at least 10%, 20%, 30%, 40%, or 10% to 50% of the outer surface of the core. In other aspects, the shell can cover a majority (e.g., greater than 50%) of the outer surface of the core. In some aspects, the shell can cover greater than 50%, at least 60%, at least 70%, at least 80%, at least 90%, or 100% of the outer surface of the core. In certain aspects, the shell can cover 60% to 100% or 80% to 100% or 90% to 100% of the outer surface of the core. In some aspects, the weight ratio of the shell to the core in the core-shell fertilizer particle can be about 2:1 to 9:1. In some aspects, the shell can make up about 85% to 95% of the total weight of the core-shell particle. In other aspects, the core can make up about 5% to 15% of the total weight of the core-shell particle. In some aspects, the core can be a pelletized, a compacted, and/or agglomerated core. In some aspects, the shell can contain a solidified aqueous urea melt, coated onto at least a portion of the outer surface of the core. The shell can comprise 70 to 99 wt. %, preferably 90 to 97 wt. %, or about 95 wt. %, of the total weight of a core-shell particle or a plurality of core-shell particles.

The second particulate fertilizer composition can contain particles having a variety of shape and sizes. Non-limiting shapes of the second particulate fertilizer composition particles include spherical, cylindrical, puck, oval, or oblong shape. Size of the second particulate fertilizer composition particles can be larger, smaller and/or the same as the core-shell particles of the first particulate fertilizer composition. In some aspects, the second particulate fertilizer composition particles can have a longest dimension 1 to 8 mm. In some particular aspects, the second particulate fertilizer particles can have a substantially spherical shape with diameter 1 mm to 5 mm, 1 mm to 4 mm, 2 mm to 5 mm, or 2 mm to 4 mm.

One aspect of the present invention is directed to a method of making a fertilizer blend and/or increasing the storage stability of a urease inhibitor containing fertilizer. The methods can include forming and/or providing a first particulate fertilizer composition, forming and/or providing a second particulate fertilizer composition and contacting the first particulate fertilizer composition with the second particulate fertilizer composition at a weight ratio 1:9 to 9:1 to form a blend of the first particulate fertilizer composition and the second particulate fertilizer composition. The first particulate fertilizer composition and the second particulate fertilizer composition can be blended by a method known in the art (e.g., mixing or stirring the first and second compositions together—e.g., dry mixing the first and second compositions to obtain a dry mixture that includes the first and second particulate fertilizer compositions). The first particulate fertilizer composition can be formed by forming a core having an outer surface, contacting at least a portion of the outer surface of the core with an urea containing solution or urea melt, and cooling and/or drying the urea solution or urea melt in contact with the outer surface of the core to form a shell. In some aspects, the core can be formed by pelletizing, compacting, and/or granulating a composition containing a binder, a pH buffer, an urease inhibitor and optionally a plasticizer, a nitrification inhibitor, and/or a filler. In some aspects, the contacting of the urea solution or urea melt and the at least a portion of the outer surface of the core can include spraying the urea solution or urea melt onto the at least a portion of the outer surface of the core at a temperature of 110° C. to 140° C. In some particular aspects, the contacting of the urea solution or urea melt and the at least a portion of the outer surface of the core can be performed in a granulator with a bed temperature during the contacting process of 80° C. to 110° C. In some aspects, the urea solution can be an aqueous urea solution (e.g., a 90 wt. % to 96 wt. % aqueous urea solution). In some aspects, the urea solution can be an aqueous solution containing urea melt. In some aspects, the method increases the amount of a temperature and/or moisture sensitive ingredient retained in the blend over time as compared to some other blends. In some instances, the temperature and/or moisture sensitive ingredient is a urease inhibitor. In some instances, the urease inhibitor is NBPT.

One aspect of the present invention is directed to a method of fertilizing, the method comprising applying the fertilizer blend to at least a portion of a soil, a crop, or the soil and the crop. The composition of present invention can stabilize the urease inhibitor in the fertilizer blend, which can relatively reduce loss of nitrogen due to hydrolysis than would otherwise occur. Also disclosed is a method of enhancing plant growth comprising applying to soil, the plant, or the soil and the plant an effective amount of a composition comprising a fertilizer blend of the present invention.

“Core-shell particle” and/or “a particle having core-shell structure” includes a particle that includes a core and a shell in contact with at least a portion of the outer surface of the core and covering at least a portion of the outer surface of the core. In the context of the present invention, fertilizer blend particles such as core-shell particles of the first particulate fertilizer composition and/or particles of the second particulate fertilizer composition may also be referred to as a particle, granule, fertilizer granule, prill, or fertilizer prill. In some aspects, the core-shell particle can contain a single core. In some aspects, the core-shell particle can contain more than one core, and the shell can cover at least a portion of the outer surfaces of the cores. In certain aspects, the number of core(s) in a core-shell particle of the first particulate fertilizer composition can vary between the core-shell particles. In certain aspects, the number of core(s) in a core-shell particles of the first particulate fertilizer composition do not vary, for example each core-shell particle in the first particulate fertilizer composition can contain a single core.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In the context of the present invention, at least the following 20 aspects are described. Aspect 1 is directed to a fertilizer blend comprising: 10 wt. % to 90 wt. % of a first particulate fertilizer composition comprising a core comprising a binder, a pH buffering agent, and an urease inhibitor, and a shell comprising urea, wherein the shell covers at least a portion of an outer surface of the core; and 10 wt. % to 90 wt. % of a second particulate fertilizer composition, wherein the second particulate fertilizer composition is blended with the first particulate fertilizer composition. Aspect 2 is directed to the fertilizer blend of aspect 1, wherein the second particulate fertilizer composition comprises ammonium sulfate, monoammonium phosphate (MAP), diammonium phosphate (DAP), muriate of potash (MOP), monopotassium phosphate (MKP), triple super phosphate (TSP), rock phosphate, single super phosphate (SSP), or any combination thereof. Aspect 3 is directed to the fertilizer blend of any one of aspects 1 or 2, wherein the second particulate fertilizer composition comprises MAP and MOP, and the fertilizer blend comprises 10 wt. % to 50 wt. %, of the first particulate fertilizer composition, 30 wt. % to 70 wt. % of MAP and 5 wt. % to 50 wt. % of MOP. Aspect 4 is directed to the fertilizer blend of any one of aspects 1 or 2, wherein the second particulate fertilizer composition comprises MAP, and the fertilizer blend comprises 30 wt. % to 70 wt. % of the first particulate fertilizer composition, and 30 wt. % to 70 wt. % of MAP. Aspect 5 is directed to the fertilizer blend of any one of aspects 1 or 2, wherein the second particulate fertilizer composition comprises ammonium sulfate, and the fertilizer blend comprises 50 wt. % to 90 wt. % of the first particulate fertilizer composition, and 10 wt. % to 50 wt. % of ammonium sulfate. Aspect 6 is directed to the fertilizer blend of any one of aspects 1 to 5, wherein the binder comprises plaster of paris, flour, bleached wheat flour, starch, gluten, kaolin, bentonite, or colloidal silica or any combination thereof, preferably plaster of paris and/or bleached wheat flour. Aspect 7 is directed to the fertilizer blend of any one of aspects 1 to 6, wherein the pH buffering agent comprises CaCO₃, Na₂CO₃, K₂CO₃, MgO, KH₂PO₄, NaHCO₃, or MgCO₃ or any combination thereof, preferably CaCO₃. Aspect 8 is directed to the fertilizer blend of any one of aspects 1 to 7, wherein the urease inhibitor comprises a thiophosphoric triamide derivative, preferably N-(n-butyl) thiophosphoric triamide (NBPT). Aspect 9 is directed to the fertilizer blend of any one of aspects 1 to 8, wherein the binder is present in the core in an amount of 10 wt. % to 95 wt. %, based on the total weight of the core. Aspect 10 is directed to the fertilizer blend of any one of aspects 1 to 9, wherein the pH buffering agent is present in the core in an amount of 5 wt. % to 60 wt. %, based on the total weight of the core. Aspect 11 is directed to the fertilizer blend of any one of aspects 1 to 10, wherein the urease inhibitor is present in the core in an amount of 1 wt. % to 5 wt. %, based on the total weight of the core. Aspect 12 is directed to the fertilizer blend of any one of aspects 1 to 11, wherein the shell comprises 50 wt. % to 100 wt. %, preferably 85 wt. % to 100 wt. %, of urea, based on the total weight of the shell. Aspect 13 is directed to the fertilizer blend of any one of aspects 1 to 12, wherein the core further comprises a nitrification inhibitor. Aspect 14 is directed to the fertilizer blend of aspect 13, wherein the nitrification inhibitor is present in the core in an amount of 10 wt. % to 30 wt. %, based on the total weight of the core. Aspect 15 is directed to the fertilizer blend of any one of aspects 13 or 14, wherein the nitrification inhibitor comprises 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1,2,4-thiadiazol (Terrazole), 2-Amino-4-chloro-6-methyl-pyrimidine (AM), 2-Mercapto-benzothiazole (MBT), or 2-Sulfanimalamidothiazole (ST) or any combination thereof, preferably DCD. Aspect 16 is directed to the fertilizer blend of any one of aspects 1 to 15, wherein the core further comprises a plasticizer in an amount of 0.01 wt. % to 5 wt. %, based on the total weight of the core. Aspect 17 is directed to the fertilizer blend of aspect 16, wherein the plasticizer comprises hydroxypropyl methylcellulose (HPMC), carboxymethyl cellulose, polyethylene glycol (PEG), guar gum, locust bean gum, xanthan gum, a natural gum, lignosulfonates, or hydroxyethylcellulose or any combination thereof, preferably HPMC. Aspect 18 is directed to the fertilizer blend of any one of aspects 1 to 17, wherein the core further comprises a filler in an amount of 1 wt. % to 60 wt. %, based on the total weight of the core. Aspect 19 is directed to the fertilizer blend of aspect 18, wherein the filler comprises silica, dried distillers grains with solubles (DDGS), CaCO₃, chalk powder, or rice husk or any combination thereof. Aspect 20 is directed to a method of fertilizing, the method comprising applying a fertilizer blend of any one of aspects 1 to 19 to at least a portion of a soil, a crop, or the soil and the crop.

Other objects, features and advantages of the present invention will become apparent from the following FIGURES, detailed description, and examples. It should be understood, however, that the FIGURES, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1 illustrates a cross section of a core-shell particle of the first particulate fertilizer composition according to an example of the present invention.

### DETAILED DESCRIPTION OF THE INVENTION

The fertilizer blend of the present invention can contain a blend of at least two separate particulate fertilizer compositions, a first particulate fertilizer composition and a second particulate fertilizer composition. The first particulate fertilizer composition can have fertilizer particles containing at least two discrete portions: a core having an outer surface and a shell in contact with at least a portion of the outer surface of the core. The core can contain a binder, a pH buffering agent, an urease inhibitor, and optionally a nitrification inhibitor, a plasticizer, and/or a filler. The shell can contain urea. The second particulate fertilizer composition can contain a plant fertilizer other than urea. In one aspect, the fertilizer blend can be a dry fertilizer blend (e.g., a dry mixture comprising a plurality of first and second fertilizer particles).

These and other non-limiting aspects of the present invention are discussed in further detail in the following sections.

### A. Fertilizer Blend

The fertilizer blend of the present invention can contain i) 10 wt. % to 90 wt. % or at least, equal to, or between any two of 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, and 90 wt. %, of a first particulate fertilizer composition and ii) 10 wt. % to 90 wt. % or at least, equal to, or between any two of 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, and 90 wt. %, of a second particulate fertilizer composition. The first and second particulate fertilizer compositions can each include a plurality of particles—e.g., the first fertilizer composition can include a plurality of the aforementioned core-shell particles, and the second fertilizer composition can include a plurality of the second fertilizer particles; the blend can include a mixture of a plurality of the core-shell particles and second fertilizer particles. The fertilizer blend can be a homogenous or heterogeneous blend of the first particulate fertilizer composition and the second particulate fertilizer composition.

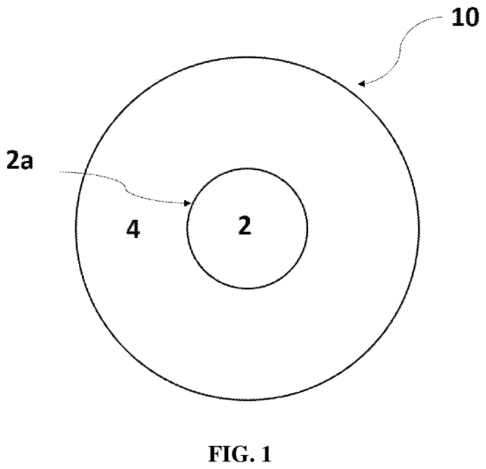

As illustrated in FIG. 1, according to an example of the present invention, the particles of the first particulate fertilizer composition can have a core-shell structure. FIG. 1 shows a cross-sectional view of a core-shell particle 10. The core-shell particle can contain a core 2 and a shell 4. While the shape of the core-shell particle 10 is depicted as being spherical, other shapes are contemplated (e.g., cylindrical shape, puck shape, oval shape, oblong shape, etc.). The overall shape of the core-shell particle can be influenced by the shape of the uncoated core (e.g., spherical, cylindrical, puck, oval, oblong, etc., core can result in a similarly shaped coated particle). The shell 4 can cover at least a portion of an outer surface 2a of the core 2. While for the core-shell particle 10 depicted in FIG. 1, the shell 4 covers an entire outer surface of the core 2, core-shell fertilizer particles with the shell 4 covering a portion of the outer surface 2a of the core 2 can readily be made and are contemplated in the context of the present invention (e.g., 5, 10, 15, 20, 25, 30, 35, 40, 45, 50, 55, 60, 65, 70, 75, 80, 85, 90, 95, 99% of the outer surface 2a of the core 2 can be covered). The core-shell structure of the particles of the first particulate fertilizer composition is at least partially maintained in the fertilizer blend. While the core-shell particle 10 depicted in FIG. 1 contains one core 2, core-shell particles containing two or more cores can readily be made.

The core 2 can contain a binder, a pH buffering agent and an urease inhibitor. In some aspects, the core can contain 10 wt. % to 95 wt. %, or at least, equal to, or between any two of 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, and 95 wt. %, of the binder, based on the total weight of the core. In some aspects, the core can contain 5 wt. % to 60 wt. %, or at least, equal to, or between any two of 5 wt. %, 10 wt. %, 15 wt. %, 20 wt. %, 25 wt. %, 30 wt. %, 35 wt. %, 40 wt. %, 45 wt. %, 50 wt. %, 55 wt. %, and 60 wt. %, of the pH buffering agent, based on the total weight of the core. In some aspects, the core can contain 0.1 wt. % to 5 wt. % or 1 wt. % to 5 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an urease inhibitor, based on total weight of the core. The core can optionally contain a plasticizer, a nitrification inhibitor and/or a filler. In some aspects, the core can contain 0.01 wt. % to 5 wt. % or at least, equal to, or between any two of 0.01 wt. %, 0.05 wt. %, 0.1 wt. %, 0.3 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an plasticizer, based on the total weight of the core. In some aspects, the core can contain 10 wt. % to 30 wt. %, or at least, equal to, or between any two of 10 wt. %, 15 wt. %, 20 wt. %, 25 wt. %, and 30 wt. % of a nitrification inhibitor, based on the total weight of the core. In some aspects, the core can contain 1 wt. % to 60 wt. %, or at least, equal to, or between any two of 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, and 60 wt. % of a filler, based on the total weight of the core.

The shell 4 can contain urea. In some aspects, the shell 4 can contain 50 wt. % to 100 wt. %, or at least, equal to, or between any two of 50 wt. %, 55 wt. %, 60 wt. %, 65 wt. %, 70 wt. %, 75 wt. %, 80 wt. %, 85 wt. %, 90 wt. %, 95 wt. %, and 100 wt. %, of urea, based on the total weight of the shell.

The second particulate fertilizer composition can contain 50 wt. % to 100 wt. %, or at least, equal to, or between any two of 50 wt. %, 55 wt. %, 60 wt. %, 65 wt. %, 70 wt. %, 75 wt. %, 80 wt. %, 85 wt. %, 90 wt. %, 95 wt. %, and 100 wt. %, of an additional plant fertilizer other than urea. In some aspects, the second particulate fertilizer composition can contain two or more additional plant fertilizers other than urea. In some particular aspects, the second particulate fertilizer composition can contain particles containing the two or more additional plant fertilizers. In some particular aspects, the two or more additional plant fertilizers can be included in second particulate fertilizer composition as two or more types of particles.

In some particular aspects, the second particulate fertilizer composition can contain MAP, and the fertilizer blend can contain 30 wt. % to 70 wt. %, or at least, equal to, or between any two of 30 wt. %, 35 wt. %, 40 wt. %, 45 wt. %, 50 wt. %, 55 wt. %, 60 wt. %, 65 wt. %, and 70 wt. % of the first particulate fertilizer composition, and 30 wt. % to 70 wt. %, or at least, equal to, or between any two of 30 wt. %, 35 wt. %, 40 wt. %, 45 wt. %, 50 wt. %, 55 wt. %, 60 wt. %, 65 wt. %, and 70 wt. % of MAP, based on total weight of the fertilizer blend. The first particulate fertilizer composition can include core-shell particles with a core containing 30 wt. % to 50 wt. % or at least, equal to, or between any two of 30 wt. %, 35 wt. %, 40 wt. %, 45 wt. %, and 50 wt. %, of plaster of paris, 5 wt. % to 20 wt. % or at least, equal to, or between any two of 5 wt. %, 10 wt. %, 15 wt. %, and 20 wt. %, of bleached wheat flour, 30 wt. % to 55 wt. % or at least, equal to, or between any two of 30 wt. %, 35 wt. %, 40 wt. %, 45 wt. %, 50 wt. %, and 55 wt. % of a pH buffering agent such as chalk powder, 1 wt. % to 5 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an urease inhibitor such as NBPT, 0.01 wt. % to 2 wt. % of or at least, equal to, or between any two of 0.01 wt. %, 0.05 wt. %, 0.1 wt. %, 0.2 wt. %, 0.3 wt. %, 0.4 wt. %, 0.5 wt. %, 1 wt. %, 1.5 wt. %, and 2 wt. % of a plasticizer such as HPMC, based on the total weight of the core, and a shell containing 90 wt. % to 100 wt. %, or at least, equal to, or between any two of 50 wt. %, 55 wt. %, 60 wt. %, 65 wt. %, 70 wt. %, 75 wt. %, 80 wt. %, 85 wt. %, 90 wt. %, 95 wt. %, and 100 wt. % of urea, based on the total weight of the shell.

In some particular aspects, the second particulate fertilizer composition can contain MOP and MAP, and the fertilizer blend can contain i) 10 wt. % to 50 wt. %, or at least, equal to, or between any two of 10 wt. %, 15 wt. %, 20 wt. %, 25 wt. %, 30 wt. %, 35 wt. %, 40 wt. %, 45 wt. %, and 50 wt. % of the first particulate fertilizer composition, ii) 30 wt. % to 70 wt. %, or at least, equal to, or between any two of 30 wt. %, 35 wt. %, 40 wt. %, 45 wt. %, 50 wt. %, 55 wt. %, 60 wt. %, 65 wt. %, and 70 wt. % of MAP and iii) 5 wt. % to 50 wt. %, or at least, equal to, or between any two of 5 wt. %, 10 wt. %, 15 wt. %, 20 wt. %, 25 wt. %, 30 wt. %, 35 wt. %, 40 wt. %, 45 wt. %, and 50 wt. % of MOP, based on total weight of the fertilizer blend. The first particulate fertilizer composition can include core-shell particles with a core containing 30 wt. % to 50 wt. % or at least, equal to, or between any two of 30 wt. %, 35 wt. %, 40 wt. %, 45 wt. %, and 50 wt. %, of plaster of paris, 5 wt. % to 20 wt. % or at least, equal to, or between any two of 5 wt. %, 10 wt. %, 15 wt. %, and 20 wt. %, of bleached wheat flour, 30 wt. % to 55 wt. % or at least, equal to, or between any two of 30 wt. %, 35 wt. %, 40 wt. %, 45 wt. %, 50 wt. %, and 55 wt. % of a pH buffering agent such as chalk powder, 1 wt. % to 5 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an urease inhibitor such as NBPT, 0.01 wt. % to 2 wt. % of or at least, equal to, or between any two of 0.01 wt. %, 0.05 wt. %, 0.1 wt. %, 0.2 wt. %, 0.3 wt. %, 0.4 wt. %, 0.5 wt. %, 1 wt. %, 1.5 wt. %, and 2 wt. % of a plasticizer such as HPMC, based on the total weight of the core, and a shell containing 90 wt. % to 100 wt. %, or at least, equal to, or between any two of 50 wt. %, 55 wt. %, 60 wt. %, 65 wt. %, 70 wt. %, 75 wt. %, 80 wt. %, 85 wt. %, 90 wt. %, 95 wt. %, and 100 wt. % of urea, based on the total weight of the shell.

In some particular aspects, the second particulate fertilizer composition can contain ammonium sulfate an the fertilizer blend can contain 50 wt. % to 90 wt. %, or at least, equal to, or between any two of 50 wt. %, 55 wt. %, 60 wt. %, 65 wt. %, 70 wt. %, 75 wt. %, 80 wt. %, 85 wt. %, and 90 wt. %, of the first particulate fertilizer composition, and 10 wt. % to 50 wt. % or at least, equal to, or between any two of 30 wt. %, 35 wt. %, 40 wt. %, 45 wt. %, and 50 wt. %, of ammonium sulfate, based on total weight of the fertilizer blend. The first particulate fertilizer composition can include core-shell particles with a core containing 30 wt. % to 50 wt. % or at least, equal to, or between any two of 30 wt. %, 35 wt. %, 40 wt. %, 45 wt. %, and 50 wt. %, of plaster of paris, 5 wt. % to 20 wt. % or at least, equal to, or between any two of 5 wt. %, 10 wt. %, 15 wt. %, and 20 wt. %, of bleached wheat flour, 30 wt. % to 55 wt. % or at least, equal to, or between any two of 30 wt. %, 35 wt. %, 40 wt. %, 45 wt. %, 50 wt. %, and 55 wt. % of a pH buffering agent such as chalk powder, 1 wt. % to 5 wt. % or at least, equal to, or between any two of 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, and 5 wt. % of an urease inhibitor such as NBPT, 0.01 wt. % to 2 wt. % of or at least, equal to, or between any two of 0.01 wt. %, 0.05 wt. %, 0.1 wt. %, 0.2 wt. %, 0.3 wt. %, 0.4 wt. %, 0.5 wt. %, 1 wt. %, 1.5 wt. %, and 2 wt. % of a plasticizer such as HPMC, based on the total weight of the core, and a shell containing 90 wt. % to 100 wt. %, or at least, equal to, or between any two of 50 wt. %, 55 wt. %, 60 wt. %, 65 wt. %, 70 wt. %, 75 wt. %, 80 wt. %, 85 wt. %, 90 wt. %, 95 wt. %, and 100 wt. % of urea, based on the total weight of the shell.

In some aspects, the urease inhibitor can include a thiophosphoric triamide derivative, and/or phenyl phosphorodiamidate (PPDA). In some aspects, the thiophosphoric triamide derivatives can be N-(n-butyl) thiophosphoric triamide (NBPT), and/or N-(n-propyl) thiophospshoric triamide (NPPT). In some aspects, the urease inhibitor can include NBPT.

In some aspects, the pH buffering agent can be CaCO₃, MgO, KH₂PO₄, NaHCO₃, aluminum, magnesium hydroxide, aluminum hydroxide/magnesium hydroxide co-precipitate, aluminum hydroxide/sodium bicarbonate co-precipitate, calcium acetate, calcium bicarbonate, calcium borate, calcium carbonate, calcium bicarbonate, calcium citrate, calcium gluconate, calcium hydroxide, dibasic sodium phosphate, dipotassium hydrogen phosphate, dipotassium phosphate, disodium hydrogen phosphate, magnesium acetate, magnesium borate, magnesium bicarbonate, magnesium carbonate, magnesium hydroxide, magnesium lactate, magnesium oxide, magnesium phosphate, magnesium silicate, magnesium succinate, magnesium tartrate, potassium acetate, potassium carbonate, potassium bicarbonate, potassium borate, potassium citrate, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium tartrate, sodium tripolyphosphate, synthetic hydrotalcite, tetrapotassium pyrophosphate, tetrasodium pyrophosphate, tripotassium phosphate, trisodium phosphate, and trometamol, and combinations thereof. In some aspects, the pH buffering agent can be CaCO₃. In some aspects, the CaCO₃ can be included as chalk powder.

In some aspects, the filler can contain one or more of silica, dried distillers grains with solubles (DDGS), CaCO₃, MgO, CaO, bone mill powder, or rice husk, or mixtures thereof. Other suitable fillers known in the art may also be used. In some aspects, a pH buffering agent can also function as a filler. For example, in some aspects, CaCO₃ is used as both the filler and as the pH buffering agent. In some instances, no other fillers or pH buffering agents other than CaCO₃ are included in the core particle.

In some aspects, the nitrification inhibitors can include 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1,2,4-thiadiazol (Terrazole), 2-Amino-4-chloro-6-methyl-pyrimidine (AM), 2-Mercapto-benzothiazole (MBT), or 2-Sulfanimalamidothiazole (ST) or any combination thereof, preferably DCD.

In some aspects, the plasticizer can be hydroxypropyl methylcellulose (HPMC), carboxymethylcellulose, hydroxyethylcellulose, polyethylene glycol (PEG), guar gum, locust bean gum, xanthan gum, other natural gums, synthetic polymers based on acrylates, polyacrylamide (PAM), PVP, combinations of synthetic polymers, or carbomers, any combination thereof, preferably HPMC.

In some aspects, the second particular fertilizer composition can contain a plant fertilizer other than urea. In some aspects, the second particular fertilizer composition can include a phosphorus (P) source, a nitrogen (N) source other than urea, a potassium (K) source, a nitrogen and phosphorus (NP) source, a phosphorus and potassium (PK) source, a nitrogen, phosphorus, and potassium (NPK) source, a micronutrient, a calcium source, a sulfur source, or any combination thereof. In some aspects, the micronutrient can include a botanically acceptable form of an inorganic or organometallic compound such as boron, copper, iron, chloride, manganese, molybdenum, nickel, and/or zinc. In some aspects, the second particular fertilizer composition can contain ammonium sulfate, monoammonium phosphate (MAP), diammonium phosphate (DAP), muriate of potash (MOP), monopotassium phosphate (MKP), triple super phosphate (TSP), rock phosphate, single super phosphate (SSP) or any combination thereof. In some aspects, the second particular fertilizer composition can further include urea.

A number of urease inhibitors have been developed to enhance the efficiency of urea fertilizer. But their application can be challenging due to stability problems of some of the urease inhibitors under various conditions such as pH, temperature, precipitation, presence of additional fertilizer components other than urea etc. For example, NBPT is known to be a good inhibitor of urease but it is unstable under acidic pH. NBPT also decomposes when exposed directly to high temperatures, such as the temperature of a urea melt (about 135-140° C.). In the case of nitrogen containing fertilizers, after application, the soil environment can become acidic. Accordingly, urease inhibitors that are sensitive to the acidic pH degrade and will not reach their full performance capability. Including a large excess of urease inhibitors to compensate for the loss due to pH variations may not be successful, since the fertilizers, which are present in a large excess (in comparison to the urease inhibitors), continue to alter the pH of the soil environment. Also, based on particular needs such as soil type, climate, or other growing conditions additional fertilizers other than urea, along with urea are used to maximize plant growth and crop yield. NBPT can also decomposes in presence of additional plant fertilizers other than urea. Without wishing to be bound by theory, the fertilizer blend of the present invention can provide a solution to at least some of these issues. The shell of the core-shell particle can protect the urease inhibitor in the core of the core-shell particle from the additional plant fertilizers in the second particulate fertilizer composition. Further, the binder and pH buffering agent in the core and urea in the shell can protect the urease inhibitor(s) from degradation during the manufacture of the core (e.g., protection from high temperatures, high pressures, acidic pH conditions, etc.). The pH buffering agent can neutralize the acidity caused by urea hydrolysis, thereby preventing the urease inhibitors, such as, for example, NBPT, from degrading when placed in soil with an acidic pH. Thus, the pH buffering agent can increase the efficacy of urease inhibitors, for example, NBPT, and can also maintain soil pH. In some aspects, certain pH buffering agents can also function as a thermal masking material for other ingredient in the core, such as NBPT, and act as an filler. For example, in some embodiments, CaCO₃ can be used as pH buffering agent and filler and can improve the physical properties of the core, such as crush strength, homogeneity, and the release kinetics of inhibitors from the core particle. The plasticizer can promote desired continuous and uniform flow characteristics of a mixture used in forming the core.

The fertilizer blend particles of the present invention such as the first particulate fertilizer composition particles and/or the second particulate fertilizer composition particles can have desirable physical properties such as desired levels of abrasion resistance, particle strength, pelletizability, hygroscopicity, particle shape, and size distribution, which are important properties for the fertilizer.

The fertilizer blend described herein can be comprised in a composition useful for application to soil. In addition to the fertilizer blend, the composition may include other fertilizer compounds, micronutrients, primary nutrients, additional urea, additional nitrogen nutrients, insecticides, herbicides, or fungicides, or combinations thereof.

### B. Method of Making a Fertilizer Particle

The fertilizer blend of the present invention can be formed by blending the first particulate fertilizer composition and the second particulate fertilizer composition at a weight ratio of 1:9 to 9:1 or at least, equal to, or between any two of 1:9, 2:8, 3:7, 4:6, 5:5, 6:4, 7:3, 8:2 and 9:1. The first particulate fertilizer composition and the second particulate fertilizer composition can be blended by a method known in the art. For example, the first particulate fertilizer composition and the second particulate fertilizer composition can be blended by dry blending in particulate forms. In some aspects, the first particulate fertilizer composition in particulate form can be contacted and can be mixed with the second particulate fertilizer composition in particulate form, to form the fertilizer blend. The first particulate fertilizer composition and second particulate fertilizer composition can be blended e.g. mixed in an apparatus such as a blender known in the art.

The first particulate fertilizer composition can be formed by forming a core having an outer surface, contacting at least a portion of the outer surface of the core with an urea containing solution or urea melt, and cooling and/or drying the urea solution or urea melt in contact with the at least a portion of the outer surface of the core to form a shell. The core can be formed by pelletizing, compacting, and/or extruding a composition containing the core ingredients such as a binder, a pH buffering agent, an urease inhibitor and optionally a plasticizer, a filler and/or a nitrification inhibitor.

In some aspects, the pelletizing process of core formation can include forming a powdered composition containing the core ingredients and pressing the powdered composition through a die to form a pelletized core of a desired shaped. The pelletizing process can be performed using a pelletizing press known in the art. In some aspects, the core ingredients can be mixed in a mixer, such as a turbo mixer to form the powdered composition, the powdered composition from the mixer can be fed to a screw feeder connected to a pelletizing press. In some aspects, the powdered composition can be fed to the screw feeder at a rate 40 kg/hr to 100 kg/h, or 50 kg/hr to 80 kg/h. In some aspects, the pelletizing press can include twin rollers rotating at a speed 150 to 200 RPM and the powdered composition can be pressed through the die by the rollers.

In some aspects, the compacting process of core formation can include, forming a powdered composition by mixing the core ingredients in dry form, compacting the powdered composition to form a compacted composition and crushing, grinding and/or granulating the compacted composition to form the core of desired shape and size. The compacting process can be done using a roller compactor known in the art. In some aspects, the powdered composition can be compacted by feeding the powdered composition into a roller compactor containing a rotating roller and a roller in immobile phase, and forming a compacted composition in form of a sheet from the powdered composition.

In some aspects, the extrusion process of core formation can include, forming a extrudable composition containing the core ingredients, and extruding the extrudable composition. The method may also include a drying step after extruding to remove solvent that may have been added to make the composition extrudable. In some aspects, the extrudable composition can be formed by the core ingredients in dry form and adding any solvent, if needed. In some aspects, the solvent can be water. The extrusion can be done using suitable extruder apparatus known in the art and can be performed at a temperature between 0° C. and 150° C. and a screw speed from 1 to 500 rpm, wherein the extruder comprises a multi-feeder comprising extrusion components including a main drive, shaft, screw, barrel, and/or die.

The core can then be contacted with an urea solution or melted urea to form a urea-based shell, thereby forming the first particulate fertilizer composition containing the core-shell fertilizer particles. The contacting can include spraying the urea solution or urea melt onto the core particle at a temperature 100° C. to 145° C. or at least, equal to, or between any two of 100° C., 105° C., 110° C., 115° C., 120° C., 125° C., 130° C., 135° C., 140° C., and 145° C. As the urea solution or urea melt is sprayed onto the core particle, it can be cooled and dried to form a solidified outer coating or shell on at least a portion of an outer surface of the core, which can result in a core-shell fertilizer particle of the present invention. The resulting fertilizer particle can be of various sizes and shapes. In some aspects, the urea solution can be aqueous urea solution containing 80 wt. % to 98 wt. % or at least, equal to, or between any two of 80 wt. %, 95 wt. %, 90 wt. %, 91 wt. %, 92 wt. %, 93 wt. %, 94 wt. %, 95 wt. %, 96 wt. %, and 98 wt. % of urea.

### C. Methods of Using Fertilizer Particles

The fertilizer blend of the present invention can be used in methods of increasing the amount of i) nitrogen and optionally ii) phosphorus and/or potassium in soil and of enhancing plant growth. Such methods can include applying to the soil an effective amount of a composition comprising the fertilizer blend of the present invention. The method may include increasing the growth and yield of crops, trees, ornamentals, etc. such as, for example, palm, coconut, rice, wheat, corn, barley, oats, and soybeans. The method can include applying the fertilizer blend of the present invention to at least one of a soil, an organism, a liquid carrier, a liquid solvent, etc.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, S ymplocaceae, Tamaricaceae, Theaceae, Theophrastaceae, Thymelaeaceae, Tiliaceae, Ulmaceae, Verbenaceae, and/or Vitaceae family.

The effectiveness of compositions comprising the fertilizer blend of the present invention can be ascertained by measuring the amount of nitrogen in the soil at various times after applying the fertilizer composition to the soil. It is understood that different soils have different characteristics, which can affect the stability of the nitrogen in the soil. The effectiveness of a fertilizer composition can also be directly compared to other fertilizer compositions by doing a side-by-side comparison in the same soil under the same conditions.

In one aspect, the fertilizer blend of the present invention can contain particles having a density that is greater than water. This can allow the particles to sink in water rather than float. This can be especially beneficial in instances where application is intended to a crop that is at least partially or fully submerged in water. A non-limiting example of such a crop is rice, as the ground in a rice paddy is typically submerged in water. Thus, application of fertilizer blend to such crops can be performed such that the fertilizer blend particles are homogenously distributed on the ground that is submerged under water. By comparison, particles that have a density that is less than water would have a tendency to remain in or on the water surface, which could result in washing away of the particles and/or coalescence of the particles, either of which would not achieve homogenous distribution of the particles to the ground that is submerged under water.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Fertilizer Blend Preparation

Comparative fertilizer blend preparation. Comparative fertilizer blends containing i) urease inhibitor coated urea particles having a core containing urea and a coating containing urease inhibitor, where the coating covers at least a portion of an outer surface of the core, and ii) a second particulate fertilizer composition containing an additional plant fertilizer other than urea were made using the following process. Urease inhibitor coated urea was prepared using a drum coating system with a batch process. The drum coating system had a capacity of 200 grams to 2 kilograms, with a drum interchanging facility based on the required volume. The drum included four baffles each 0.5 inch in height and 1 inch in width across the drum length, that helped in mixing the urea granules. The drum coater system worked in manual mode starting from feeding, to pumping, spraying, exhausting, drying and discharging the coated material. An inhibitor containing solution was obtained from commercial sources and used to coat granular urea with a range of 2 to 3 liter per ton of urea. Initially, a required amount of sieved (>2.00 mm and <4.00 mm) granular urea product was weighed and fed into the drum. The coating solution was pumped using a peristatic pump. The pump was connected to a spray nozzle that atomized the spray using compressed air. An exhaust pipe line was placed on top of the drum to remove the compressed air. After completion of spraying the coating solution, the pump was stopped and the drum rotation continued for five additional minutes to ensure the dispersion of the coating. The product was then collected for packing. The process parameters are provided below. The inhibitor coated urea was dry blended with other fertilizers, such as monoammonium sulfate (MAP), Muriate of Potash (MOP) and Ammonium Sulfate (AS) to prepared comparative fertilizer blends 5 to 8. Individual components of the blends were weighted and mixed in zip-lock covers. Table 1 shows the composition of the comparative fertilizer blends 5-8.

Process Parameters:

Drum RPM: 20

Spray rate: 02 ml/min

Spray nozzle type: orifice

Spray nozzle distance from the coating bed: 300 to 600 mm

Atomizing air pressure: 0.1 bar

Fertilizer blend preparation. Fertilizer blends containing i) a first particulate fertilizer composition containing core-shell fertilizer particles having a core containing an urease inhibitor, and a shell containing urea where the shell covers at least a portion of an outer surface of the core, and ii) a second particulate fertilizer composition containing an additional plant fertilizer other than urea were made using the following process. A composition containing plaster of paris, bleached wheat flour, chalk powder, NBPT, and HPMC was formed into core pellets by extrusion. The core had an average diameter of 0.7-1.7 mm. The core contained, 40.39 wt. % of plaster of paris, 47.32 wt. % of chalk powder/CaCO₃, 9.79 wt. % of bleached Wheat Flour, 2.2 wt. % of NBPT, and 0.3 wt. % of HPMC, based on the total weight of the core.

Process Parameters:

Feed rate: 10 kg/hr.

Screw RPM: 200-250.

Temperature: Room temperature.

Output torque: 11-30 Nm.

The core produced as above, was coated with an aqueous urea melt solution (90-96% urea) in a granulator. The solution was then dried to form a solidified urea shell on the outer surface of the core pellets to form the core-shell particles. The granulator bed temperature was 80° C. to 110° C. The core-shell particles were dry blended with fertilizers, such as monoammonium sulfate (MAP), Muriate of Potash (MOP) and Ammonium Sulfate (AS) to prepared fertilizer blends 1 to 4. Individual components were weighted and were mixed in zip-lock covers. Table 1 shows the composition of the fertilizer blends 1-4. MAP and AS were obtained from Kynoch and MOP was obtained from a local Indian market.

TABLE 1
Different fertilizer blends prepared

| | Component wt. % | | | | |
|---|---|---|---|---|---|
| | Inhibitor | Core-shell | | | |
| Blend | coated urea | particle | MAP | MOP | AS |
| Fertilizer blend 1 | — | 20 | 50 | 30 | 0 |
| Fertilizer blend 2 | — | 37 | 52 | 11 | 0 |
| Fertilizer blend 3 | — | 50 | 50 | 0 | 0 |
| Fertilizer blend 4 | — | 75 | 0 | 0 | 25 |
| Comparative | | | | | |
| Fertilizer blend 5 | 20 | — | 50 | 30 | 0 |
| Comparative | | | | | |
| Fertilizer blend 6 | 37 | — | 52 | 11 | 0 |
| Comparative | 50 | — | 50 | 0 | 0 |
| Fertilizer blend 7 | | | | | |
| Comparative | 75 | — | 0 | 0 | 25 |
| Fertilizer blend 8 | | | | | |

### Example 2

### Urease Stability in the Fertilizer Blends

Method: The inhibitor stability was monitored in blended samples at two different storage conditions, a) at room conditions and b) at 40±2° C. and 75±5% relative humidity. Fertilizer granules from the different blends were handpicked at different time intervals (as shown in tables 2-4) and the urease inhibitor NBPT was quantified using HPLC technique. Unblended core-shell particles and inhibitor coated urea samples were used as control samples.

TABLE 2
Percentage NBPT recovery in blended
samples stored at room conditions.

| Sample | Day 0 | Day 7 | Day 14 |
|---|---|---|---|
| Fertilizer blend 3 | 100 | 79.4 | 65.8 |
| Fertilizer blend 4 | 100 | 73.7 | 62.4 |
| Comparative | 100 | 56.9 | 15.5 |
| Fertilizer blend 7 | | | |
| Comparative | 100 | 34.2 | 43.2 |
| Fertilizer blend 8 | | | |

TABLE 3
Percentage NBPT recovery in blended and control
samples stored at room conditions.

| Sample | Day 0 | Day 3 | Day 14 | Day 31 | Day 60 |
|---|---|---|---|---|---|
| Core-Shell particle | 100 | 98.2 | 100.9 | 91.8 | 100.0 |
| Fertilizer blend 1 | 100 | 89.1 | 44.5 | 27.3 | 11.8 |
| Fertilizer blend 2 | 100 | 95.5 | 43.6 | 30.0 | 9.1 |
| Inhibitor coated urea | 100 | 101.0 | 100.0 | 94.1 | 96.0 |
| Comparative | 100 | 88.1 | 18.8 | 2.0 | 0.0 |
| Fertilizer blend 5 | | | | | |
| Comparative | 100 | 89.1 | 15.8 | 0.0 | 0.0 |
| Fertilizer blend 6 | | | | | |

TABLE 4
Percentage NBPT recovery in blended and control samples stored at
40 ± 2° C. and 75 ± 5% relative humidity.

| Sample | Day 0 | Day 1 | Day 15 | Day 30 |
|---|---|---|---|---|
| Core-Shell particle | 100 | 101.8 | 94.5 | 85.5 |
| Fertilizer blend 1 | 100 | 52.7 | 7.3 | 0.0 |
| Fertilizer blend 2 | 100 | 48.2 | 4.5 | 0.0 |
| Inhibitor coated urea | 100 | 102.0 | 97.0 | 86.1 |
| Comparative | 100 | 19.8 | 0.0 | 0.0 |
| Fertilizer blend 5 | | | | |
| Comparative | 100 | 19.8 | 0.0 | 0.0 |
| Fertilizer blend 6 | | | | |

Results: Tables 3 and 4 show NBPT stability were higher in the unblended samples (e.g. core-shell particle and inhibitor coated urea) compared to the blended samples, indicating that NBPT degrades in presence of additional fertilizers (e.g. MAP, MOP, and/or AS) other than urea. Results presented in Tables 2 to 4 show NBPT stability was higher in the fertilizer blends 1 to 4, compared to the comparative fertilizer blends 5 to 8. For example, fertilizer blend 1 and comparative fertilizer blend 5 contain similar wt. % of MAP and MOP. When stored at room conditions or at 40±2° C. and 75±5% relative humidity, NBPT recovery, which indicates NBPT stability, for the fertilizer blend 1 was higher compared to the comparative fertilizer blend 5. For example, when stored at room conditions for 31 days, NBPT recovery for fertilizer blend 1 was 27.3%, whereas at the same conditions only 2% NBPT recovery was observed for the comparative fertilizer blend 5. Similar trends for NBPT recovery was also observed for the fertilizer blend 2 vs. comparative fertilizer blend 6 (containing similar wt. % of MAP and MOP), fertilizer blend 3 vs. comparative fertilizer blend 7 (containing similar wt. % of MAP), and fertilizer blend 4 vs. comparative fertilizer blend 8 (containing similar wt. % of AS).

1. A fertilizer blend comprising:
10 wt. % to 90 wt. % of a first particulate fertilizer composition comprising a core comprising a binder, a pH buffering agent, and an urease inhibitor, and a shell comprising urea, wherein the shell covers at least a portion of an outer surface of the core; and
10 wt. % to 90 wt. % of a second particulate fertilizer composition,
wherein the second particulate fertilizer composition is blended with the first particulate fertilizer composition.

2. The fertilizer blend of claim 1, wherein the second particulate fertilizer composition comprises ammonium sulfate, monoammonium phosphate (MAP), diammonium phosphate (DAP), muriate of potash (MOP), monopotassium phosphate (MKP), triple super phosphate (TSP), rock phosphate, single super phosphate (SSP), or any combination thereof.

3. The fertilizer blend of claim 1, wherein the second particulate fertilizer composition comprises MAP and MOP, and the fertilizer blend comprises 10 wt. % to 50 wt. %, of the first particulate fertilizer composition, 30 wt. % to 70 wt. % of MAP and 5 wt. % to 50 wt. % of MOP.

4. The fertilizer blend of claim 1, wherein the second particulate fertilizer composition comprises MAP, and the fertilizer blend comprises 30 wt. % to 70 wt. % of the first particulate fertilizer composition, and 30 wt. % to 70 wt. % of MAP.

5. The fertilizer blend of claim 1, wherein the second particulate fertilizer composition comprises ammonium sulfate, and the fertilizer blend comprises 50 wt. % to 90 wt. % of the first particulate fertilizer composition, and 10 wt. % to 50 wt. % of ammonium sulfate.

6. The fertilizer blend of claim 1, wherein the binder comprises plaster of paris, flour, bleached wheat flour, starch, gluten, kaolin, bentonite, or colloidal silica or any combination thereof.

7. The fertilizer blend of claim 1, wherein the pH buffering agent comprises CaCO₃, Na₂CO₃, K₂CO₃, MgO, KH₂PO₄, NaHCO₃, or MgCO₃ or any combination thereof.

8. The fertilizer blend of claim 1, wherein the urease inhibitor comprises a thiophosphoric triamide derivative.

9. The fertilizer blend of claim 1, wherein the binder is present in the core in an amount of 10 wt. % to 95 wt. %, based on the total weight of the core.

10. The fertilizer blend of claim 1, wherein the pH buffering agent is present in the core in an amount of 5 wt. % to 60 wt. %, based on the total weight of the core.

11. The fertilizer blend of claim 1, wherein the urease inhibitor is present in the core in an amount of 1 wt. % to 5 wt. %, based on the total weight of the core.

12. The fertilizer blend of claim 1, wherein the shell comprises 50 wt. % to 100 wt. % of urea, based on the total weight of the shell.

13. The fertilizer blend of claim 1, wherein the core further comprises a nitrification inhibitor.

14. The fertilizer blend of claim 13, wherein the nitrification inhibitor is present in the core in an amount of 10 wt. % to 30 wt. %, based on the total weight of the core.

15. The fertilizer blend of claim 13, wherein the nitrification inhibitor comprises 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1,2,4-thiadiazol (Terrazole), 2-Amino-4-chloro-6-methyl-pyrimidine (AM), 2-Mercapto-benzothiazole (MBT), or 2-Sulfanimalamidothiazole (ST) or any combination thereof.

16. The fertilizer blend of claim 1, wherein the core further comprises a plasticizer in an amount of 0.01 wt. % to 5 wt. %, based on the total weight of the core.

17. The fertilizer blend of claim 16, wherein the plasticizer comprises hydroxypropyl methylcellulose (HPMC), carboxymethyl cellulose, polyethylene glycol (PEG), guar gum, locust bean gum, xanthan gum, a natural gum, lignosulfonates, or hydroxyethylcellulose or any combination thereof.

18. The fertilizer blend of claim 1, wherein the core further comprises a filler in an amount of 1 wt. % to 60 wt. %, based on the total weight of the core.

19. The fertilizer blend of claim 18, wherein the filler comprises silica, dried distillers grains with solubles (DDGS), CaCO₃, chalk powder, or rice husk or any combination thereof.

20. A method of fertilizing, the method comprising applying a fertilizer blend of claim 1 to at least a portion of a soil, a crop, or the soil and the crop.
